(19) United States
(12) Patent Application Publication
(10) Pub. No.: US 2026/0270000 A1
(43) Pub. Date: Sep. 10, 2026

(54) DOWNLINK DECODING RELIABILITY IN A WIRELESS COMMUNICATIONS SYSTEM (WCS)

(71) Applicant: CORNING OPTICAL COMMUNICATIONS LLC, Charlotte, NC (US)

(72) Inventors: Naveen Aggarwal, Delhi (District Shahdara) (IN); Ankush Sharma, SriGanganagr (IN)

(21) Appl. No.: 19/074,859

(22) Filed: Mar. 10, 2025

(51) Int. Cl. H04L 5/00; H04W 72/23

(52) U.S. Cl. CPC H04L 5/0048; H04W 72/23

(57) ABSTRACT

Improving downlink decoding reliability in a wireless communications system (WCS) is disclosed. Herein, a radio access node(s) (e.g., base station) is configured to allocate enough demodulation reference signal (DMRS) symbols (a.k.a. DMRS resource elements) to help a user equipment(s) to improve downlink channel estimation, such as physical downlink shared channel (PDSCH) estimation. Specifically, the radio access node(s) is configured to allocate an additional physical resource block(s) (PRB(s)) to the user equipment(s) when a total number of DMRS symbols already allocated to the user equipment(s) falls below a predefined threshold. By allocating enough DMRS symbols to the user equipment(s), the user equipment(s) can perform better downlink channel estimation to help reduce block error rate (BLER) and thereby improve downlink decoding reliability.

### BACKGROUND

The disclosure relates generally to improving downlink decoding reliability in a wireless communications system (WCS), which can include a fifth generation (5G) non-standalone (NSA) system and/or a 5G standalone (SA) system.

Wireless communication is rapidly growing, with ever-increasing demands for high-speed mobile data communication. As an example, local area wireless services (e.g., so-called “Wi-Fi” systems) and wide area wireless services are being deployed in many different types of areas (e.g., coffee shops, airports, libraries, etc.). Communications systems have been provided to transmit and/or distribute communications signals to wireless nodes called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of radio nodes/base stations that transmit communications signals distributed over physical communications medium remote units forming RF antenna coverage areas, also referred to as “antenna coverage areas.” The remote units each contain or are configured to couple to one or more antennas configured to support the desired frequency(ies) of the radio nodes to provide the antenna coverage areas. Antenna coverage areas can have a radius in a range from meters up to kilometers, as an example. Another example of a communications system includes radio nodes, such as base stations, that form cell radio access networks, wherein the radio nodes are configured to transmit communications signals wirelessly directly to client devices without being distributed through intermediate remote units.

For example, FIG. 1 is an example of a WCS 100 that includes a radio node 102 configured to support one or more service providers 104(1)-104(N) as signal sources (also known as “carriers” or “service operators”—e.g., mobile network operators (MNOs)) and wireless client devices 106(1)-106(W). For example, the radio node 102 may be a base station (eNodeB) that includes modem functionality and is configured to distribute downlink communications signals 108(1)-108(S) to the wireless client devices 106(1)-106(W) based on communications signals 110(1)-110(N) received from the service providers 104(1)-104(N). The downlink communications signals 108(1)-108(S) of each respective service provider 104(1)-104(N) in their different spectrums are radiated through an antenna 112 to the wireless client devices 106(1)-106(W) in a communication range of the antenna 112. For example, the antenna 112 may be an antenna array. As another example, the radio node 102 in the WCS 100 in FIG. 1 can be a small cell radio access node (“small cell”) that is configured to support the multiple service providers 104(1)-104(N) by distributing the downlink communications signals 108(1)-108(S) for the multiple service providers 104(1)-104(N) based on respective communications signals 110(1)-110(N) received from a respective evolved packet core (EPC) network CN₁-CN_{N} of the service providers 104(1)-104(N) through interface connections. The radio node 102 includes radio circuits 118(1)-118(N) for each service provider 104(1)-104(N) that are configured to create multiple simultaneous RF beams (“beams”) 120(1)-120(N) for the downlink communications signals 108(1)-108(S) to serve multiple wireless client devices 106(1)-106(W). For example, the multiple RF beams 120(1)-120(N) may support multiple-input, multiple-output (MIMO) communications.

The radio node 102 of the WCS 100 in FIG. 1 may be configured to support service providers 104(1)-104(N) that have a different frequency spectrum and do not share the spectrum. Thus, in this instance, the communications signals 110(1)-110(N) from the different service providers 104(1)-104(N) do not interfere with each other even if transmitted by the radio node 102 at the same time. The radio node 102 may also be configured as a shared spectrum communications system where the multiple service providers 104(1)-104(N) have a shared spectrum. In this regard, the capacity supported by the radio node 102 for the shared spectrum is split (i.e., shared) between the multiple service providers 104(1)-104(N) for providing services to the subscribers.

The radio node 102 in FIG. 1 can also be coupled to a distributed communications system (DCS), such as a distributed antenna system (DAS), such that the radio circuits 118(1)-118(N) remotely distribute the communications signals 110(1)-110(N) of the multiple service providers 104(1)-104(N) to remote units. The remote units can each include an antenna array that includes tens or even hundreds of antennas for concurrently radiating the communications signals 110(1)-110(N) to subscribers using spatial multiplexing. Herein, the spatial multiplexing is a scheme that takes advantage of the differences in RF channels between transmitting and receiving antennas to provide multiple independent streams between the transmitting and receiving antennas, thus increasing throughput by sending data over parallel streams. Accordingly, the remote units can be said to radiate the communications signals 110(1)-110(N) to subscribers based on a massive multiple-input multiple-output (M-MIMO) scheme.

The WCS 100 may be configured to operate as a 5G standalone (SA) system or a 5G non-standalone (NSA) system. When operating as the 5G SA system, the radio node 102 can function as a 5G or 5G-NR base station (a.k.a. gNodeB) to service the wireless client devices 106(1)-106(W). When operating as the 5G NSA system, the radio node 102 can function as a master base station (a.k.a. MeNB) to provide control plane (C-plane) services to the wireless client devices 106(1)-106(W) or as a secondary base station (a.k.a. SgNB) to provide user plane (U-plane) services to the wireless client devices 106(1)-106(W).

In the WCS 100, each of the downlink communications signals 108(1)-108(S) can be carried in a physical downlink shared channel (PDSCH). As the PDSCH can be affected by such impairments as Doppler shift, noise, and fading, the radio node 102 periodically transmits a demodulation reference signal (DMRS) symbol(s) within the PDSCH to help the wireless client devices 106(1)-106(W) to perform proper PDSCH estimation as part of coherent demodulation of the PDSCH. Specifically, the radio node 102 can configure the DMRS symbol(s) in each physical resource block (PRB) in accordance with various configuration schemes as defined in respective third-generation partnership project (3GPP) standards. Studies have found that a total number of the DMRS symbols allocated to each of the wireless client devices 106(1)-106(W) can determine whether each of the wireless client devices 106(1)-106(W) can reliably decode the downlink communications signals 108(1)-108(S) received in the PDSCH. As such, it is desirable to allocate enough DMRS symbols to each of the downlink communications signals 108(1)-108(S) to help improve downlink decoding reliability.

### SUMMARY

Embodiments disclosed herein include improving downlink decoding reliability in a wireless communications system (WCS). Herein, a radio access node(s) (e.g., base station) is configured to allocate enough demodulation reference signal (DMRS) symbols (a.k.a. DMRS resource elements) to help a user equipment(s) to improve downlink channel estimation, such as physical downlink shared channel (PDSCH) estimation. Specifically, the radio access node(s) is configured to allocate an additional physical resource block(s) (PRB(s)) to the user equipment(s) when a total number of DMRS symbols already allocated to the user equipment(s) falls below a predefined threshold. By allocating enough DMRS symbols to the user equipment(s), the user equipment(s) can perform better downlink channel estimation to help reduce block error rate (BLER) and thereby improve downlink decoding reliability.

One exemplary embodiment of the disclosure relates to a radio access node. The radio access node is configured to calculate a total number of DMRS symbols allocated to a selected user equipment (UE). The radio access node is also configured to determine whether the total number of DMRS symbols allocated to the selected UE is lower than a predefined threshold. If the determined total number of allocated DMRS symbols is lower than the predefined threshold, the radio access node is further configured to allocate one or more additional PRBs to the selected UE until the total number of DMRS symbols allocated to the selected UE is higher than or equal to the predefined threshold.

An additional exemplary embodiment of the disclosure relates to a method for improving downlink decoding reliability in a WCS. The method includes calculating a total number of DMRS symbols allocated to a selected UE. The method also includes determining whether the total number of DMRS symbols allocated to the selected UE is lower than a predefined threshold. The method also includes, if the determined total number of allocated DMRS symbols is lower than the predefined threshold, allocating one or more additional PRBs to the selected UE until the total number of DMRS symbols allocated to the selected UE is higher than or equal to the predefined threshold.

An additional exemplary embodiment of the disclosure relates to a WCS. The WCS includes at least one radio access node. The at least one radio access node is configured to calculate a total number of DMRS symbols allocated to a selected UE. The at least one radio access node is also configured to determine whether the total number of DMRS symbols allocated to the selected UE is lower than a predefined threshold. If the determined total number of allocated DMRS symbols is lower than the predefined threshold, the at least one radio access node is further configured to allocate one or more additional PRBs to the selected UE until the total number of DMRS symbols allocated to the selected UE is higher than or equal to the predefined threshold.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIG. 2A is a schematic diagram providing an exemplary illustration of a physical resource block (PRB) wherein multiple demodulation reference signal (DMRS) symbols can be provided;

FIGS. 2B-2M are schematic diagrams providing exemplary illustrations of various DMRS allocations in the PRB of FIG. 2A;

FIG. 3 is a schematic diagram of an exemplary WCS wherein a radio access node(s) can be configured according to embodiments of the present disclosure to improve downlink decoding reliability in a user equipment (UE);

FIG. 4 is a schematic diagram providing an exemplary illustration of the radio access node(s) in FIG. 3 configured to help the UE to improve downlink decoding reliability;

FIG. 5 is a flowchart of an exemplary process whereby the radio access node(s) of FIG. 4 can help the UE to improve downlink decoding reliability;

FIG. 6 is a partial schematic cut-away diagram of an exemplary building infrastructure in a WCS, such as the WCS of FIG. 3 that includes the radio access node(s) of FIG. 4 to help the UE to improve downlink decoding reliability based on embodiments of the present disclosure;

FIG. 7 is a schematic diagram of an exemplary mobile telecommunications environment that can include the WCS of FIG. 3 that includes the radio access node(s) of FIG. 4 to help the UE to improve downlink decoding reliability based on embodiments of the present disclosure; and

FIG. 8 is a schematic diagram of a representation of an exemplary computer system that can be included in or interfaced with any of the components in the WCS of FIG. 3 and the radio access node(s) in FIG. 4 to help the UE to improve downlink decoding reliability based on embodiments of the present disclosure, wherein the exemplary computer system is configured to execute instructions from an exemplary computer-readable medium.

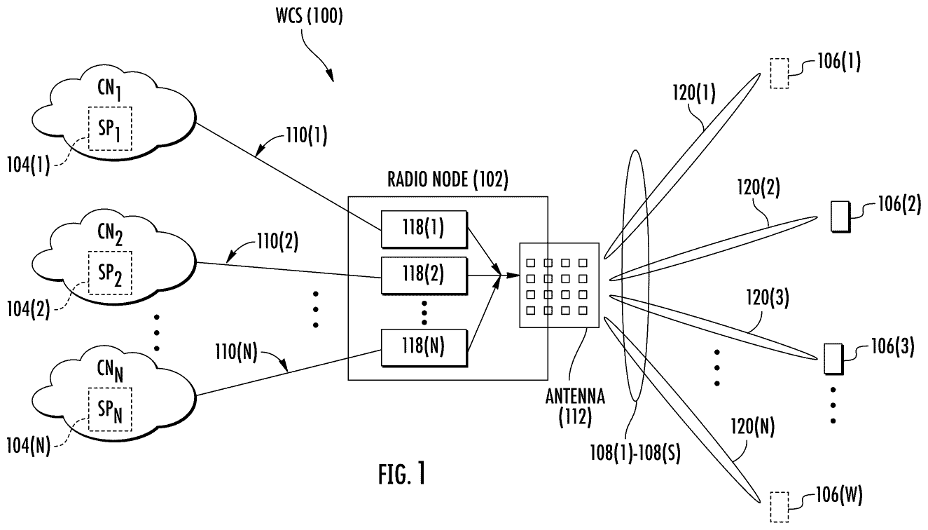

### DETAILED DESCRIPTION

Embodiments disclosed herein include improving downlink decoding reliability in a wireless communications system (WCS). Herein, a radio access node(s) (e.g., base station) is configured to allocate enough demodulation reference signal (DMRS) symbols (a.k.a. DMRS resource elements) to help a user equipment(s) to improve downlink channel estimation, such as physical downlink shared channel (PDSCH) estimation. Specifically, the radio access node(s) is configured to allocate an additional physical resource block(s) (PRB(s)) to the user equipment(s) when a total number of DMRS symbols already allocated to the user equipment(s) falls below a predefined threshold. By allocating enough DMRS symbols to the user equipment(s), the user equipment(s) can perform better downlink channel estimation to help reduce block error rate (BLER) and thereby improve downlink decoding reliability.

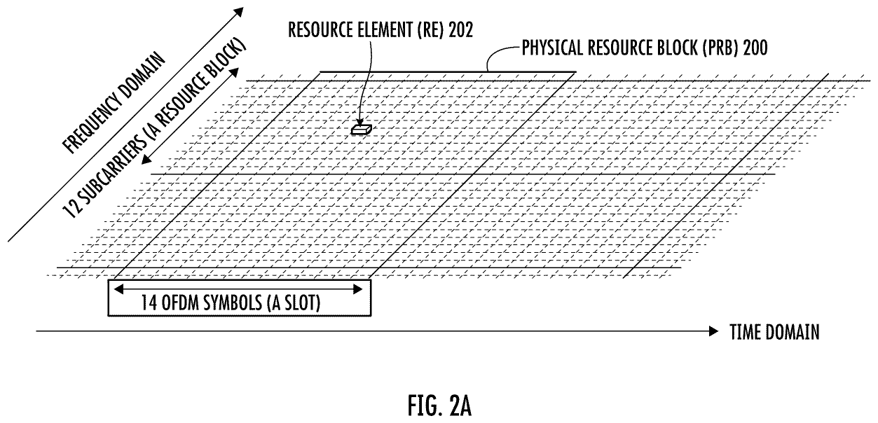

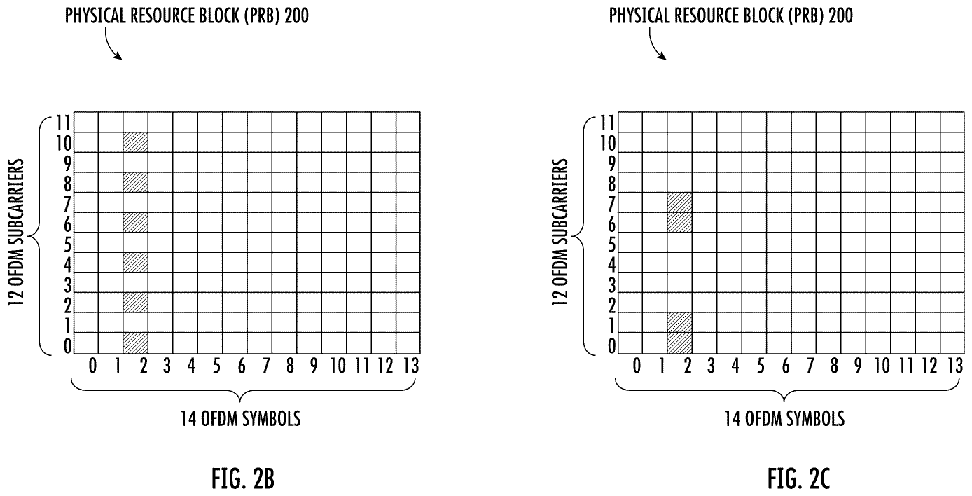

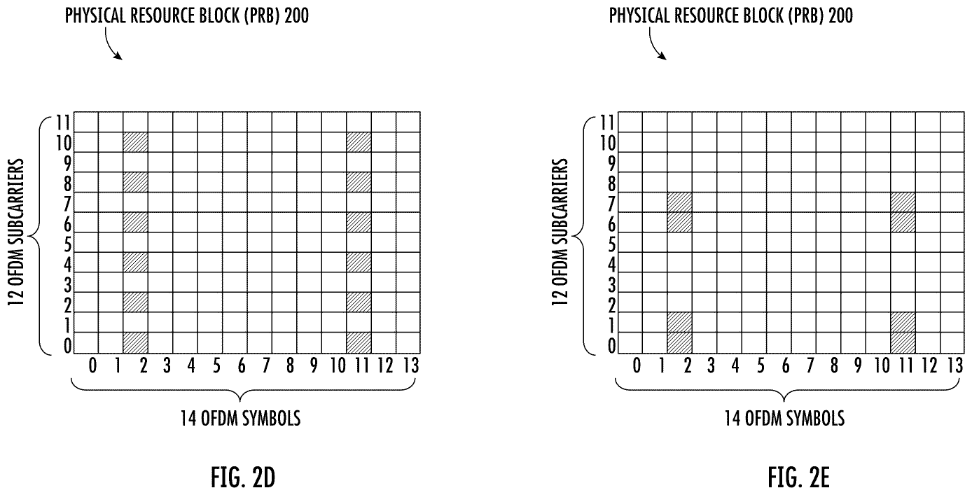

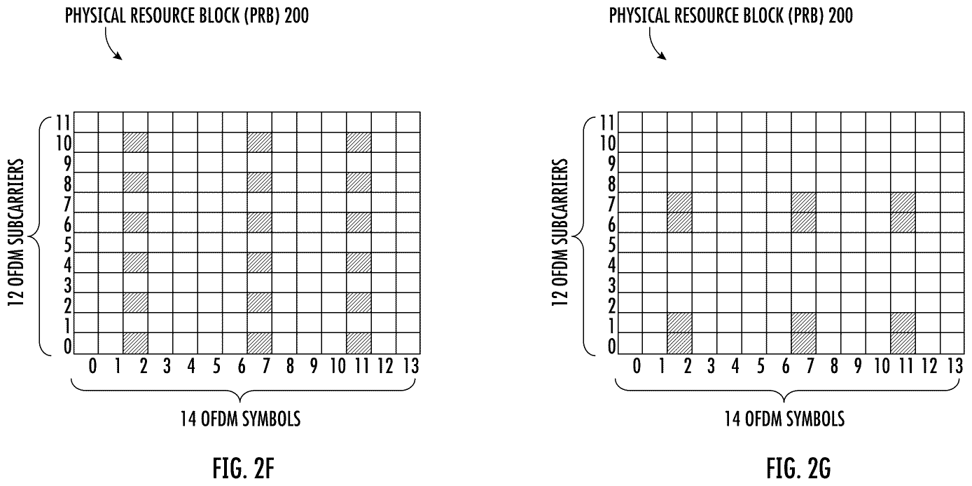

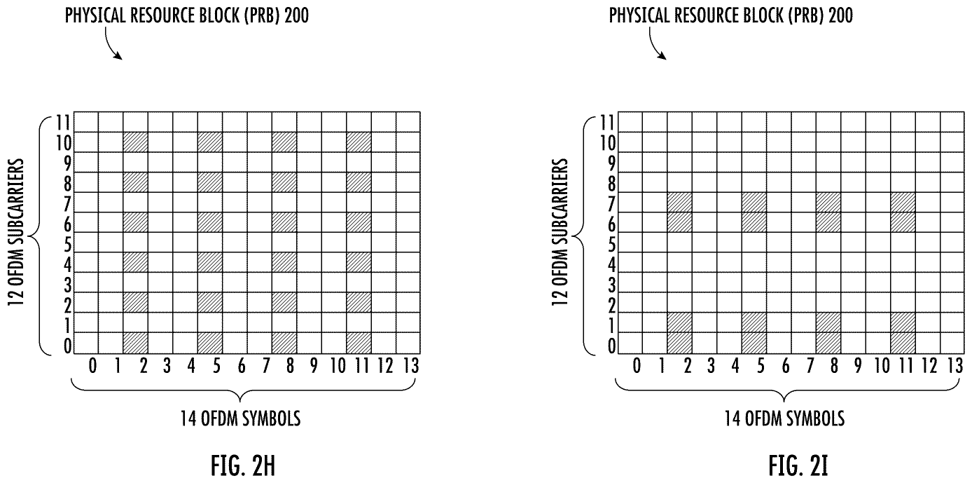

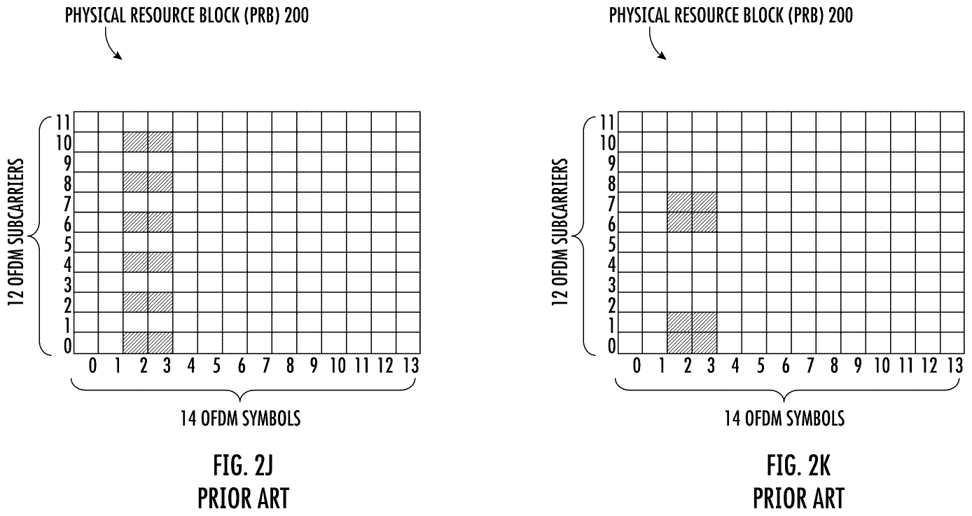

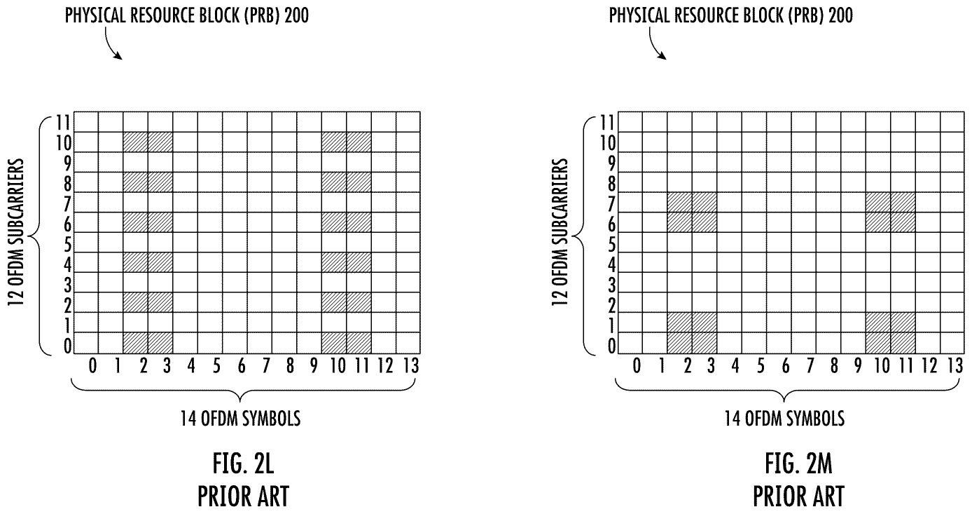

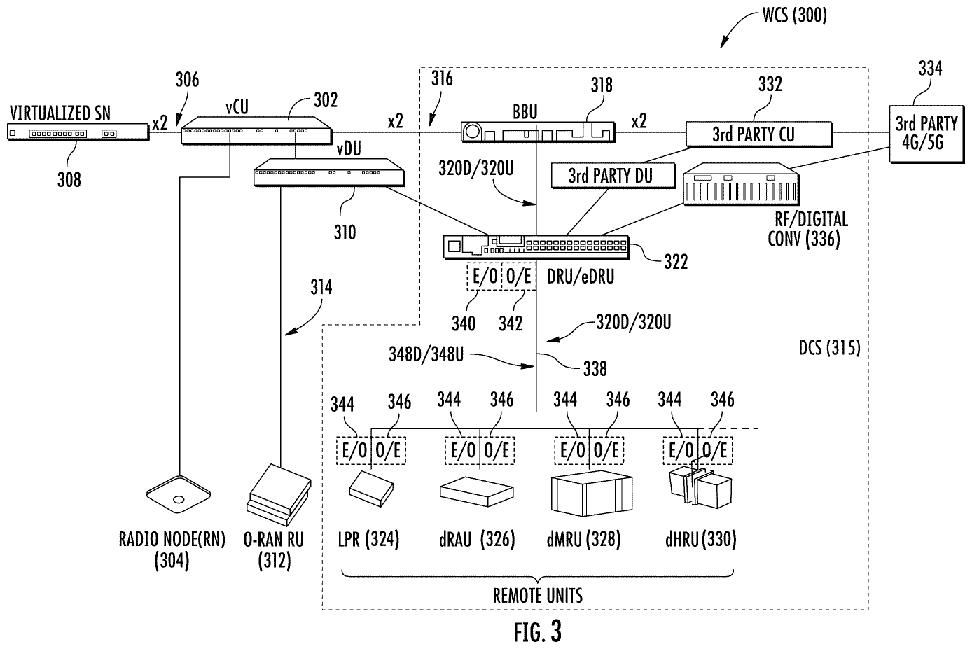

Before discussing the radio access node of the present disclosure, starting at FIG. 3, a brief overview of a fifth generation (5G) physical resource block (PRB) and various DMRS symbol allocation schemes in the PRB are first provided with reference to FIGS. 2A-2M to help explain the technical problem to be solved by embodiments of the present disclosure.

In 5G and 5G new radio (5G-NR) systems, a PRB is a smallest physical time-frequency resource for allocating DMRS symbols and scheduling downlink/uplink communications. FIG. 2A is a schematic diagram of an exemplary PRB 200 as defined by third-generation partnership project (3GPP) standards.

In a non-limiting example, the PRB 200 includes 14 adjacent OFDM symbols in a time domain and 12 OFDM subcarriers in a frequency domain. The 14 OFDM symbols in the time domain are also known as an OFDM slot. In the PRB 200, any one subcarrier in any one OFDM symbol defines a resource element (RE) 202. In this regard, the PRB 200 includes a total of 168(12×14) REs 202.

The 3GPP standard defines various DMRS allocation schemes based on a set of DMRS configuration parameters as defined by mapping type (A or B), configuration type (1 or 2), and a total number of DMRS symbols (1 to 4) in each OFDM slot. In this regard, FIGS. 2B-2M are schematic diagrams providing exemplary illustrations of various DMRS symbol allocations in the PRB 200 of FIG. 2A under mapping type A.

FIG. 2B illustrates a DMRS symbol allocation in the PRB 200 based on configuration type 1. Herein, a total of six (6) DMRS symbols are allocated as illustrated. FIG. 2C illustrates a DMRS symbol allocation in the PRB 200 based on configuration type 2. Herein, a total of four (4) DMRS symbols are allocated as illustrated.

FIG. 2D illustrates a DMRS symbol allocation in the PRB 200 based on configuration type 1. Herein, a total of twelve (12) DMRS symbols are allocated as illustrated. FIG. 2E illustrates a DMRS symbol allocation in the PRB 200 based on configuration type 2. Herein, a total of eight (8) DMRS symbols are allocated as illustrated.

FIG. 2F illustrates a DMRS symbol allocation in the PRB 200 based on configuration type 1. Herein, a total of eighteen (18) DMRS symbols are allocated as illustrated. FIG. 2G illustrates a DMRS symbol allocation in the PRB 200 based on configuration type 2. Herein, a total of twelve (12) DMRS symbols are allocated as illustrated.

FIG. 2H illustrates a DMRS symbol allocation in the PRB 200 based on configuration type 1. Herein, a total of twenty-four (24) DMRS symbols are allocated as illustrated. FIG. 2I illustrates a DMRS symbol allocation in the PRB 200 based on configuration type 2. Herein, a total of sixteen (16) DMRS symbols are allocated as illustrated.

FIG. 2J illustrates a DMRS symbol allocation in the PRB 200 based on configuration type 1. Herein, a total of twelve (12) DMRS symbols are allocated as illustrated. FIG. 2K illustrates a DMRS symbol allocation in the PRB 200 based on configuration type 2. Herein, a total of eight (8) DMRS symbols are allocated as illustrated.

FIG. 2L illustrates a DMRS symbol allocation in the PRB 200 based on configuration type 1. Herein, a total of twenty-four (24) DMRS symbols are allocated as illustrated. FIG. 2M illustrates a DMRS symbol allocation in the PRB 200 based on configuration type 2. Herein, a total of sixteen (16) DMRS symbols are allocated as illustrated.

In addition to providing the DMRS symbols based on any of the DMRS allocation schemes in FIGS. 2B-2M, resources for downlink and uplink communications are allocated based on carrier bandwidth part (BWP), which is a contiguous set of the PRB 200 selected for a given numerology on a given carrier. According to the 3GPP standard, each user equipment (UE) can be configured with up to four (4) BWPs in downlink and uplink, respectively. As such, once the BWP is selected, a maximum number of the PRB 200 that can be allocated to the UE will be in the range of [1, BWPSize].

Studies have found that a total number of DMRS symbols allocated to a UE can affect the UE's capability to reliably decode data communicated in a downlink channel (e.g., PDSCH). Specifically, it has been observed that the UE may not be able to reliably decode the downlink data when the total number of DMRS symbols allocated to the UE is below a certain threshold value. In contrast, the UE will be able to reliably decode the downlink data when the total number of DMRS symbols allocated to the UE is above the threshold value. As such, it is desirable to allocate enough DMRS symbols to the UE to help improve downlink decoding reliability.

In this regard, FIG. 3 is a schematic diagram of an exemplary WCS 300 that can be configured according to embodiments of the present disclosure to improve downlink decoding reliability. Herein, the WCS 300 can support both legacy 4G LTE, 5G SA, and 5G NSA communications systems. As shown in FIG. 3, a centralized services node 302 is provided and is configured to interface with a core network to exchange communications data and distribute the communications data as radio signals to various wireless nodes. In this example, the centralized services node 302 is configured to support distributed communications services to at least one radio node 304 (e.g., 5G or 5G-NR gNB). Despite the fact that only one radio node 304 is shown in FIG. 3, it should be appreciated that the WCS 300 can be configured to include additional numbers of the radio node 304, as needed.

The functions of the centralized services node 302 can be virtualized through, for example, an x2 interface 306 to another services node 308. The centralized services node 302 can also include one or more internal radio nodes that are configured to be interfaced with a distribution unit (DU) 310 to distribute communications signals to one or more open radio access network (O-RAN) remote units (RUs) 312 that are configured to be communicatively coupled through an O-RAN interface 314. The O-RAN RUs 312 are each configured to communicate downlink and uplink communications signals in a respective coverage cell.

The centralized services node 302 can also be interfaced with a distributed communications system (DCS) 315 through an x2 interface 316. Specifically, the centralized services node 302 can be interfaced with a digital baseband unit (BBU) 318 that can provide a digital signal source to the centralized services node 302. The digital BBU 318 may be configured to provide a signal source to the centralized services node 302 to provide downlink communications signals 320D to a digital routing unit (DRU) 322 as part of a digital distributed antenna system (DAS). The DRU 322 is configured to split and distribute the downlink communications signals 320D to different types of remote units, including a low-power remote unit (LPR) 324, a radio antenna unit (dRAU) 326, a mid-power remote unit (dMRU) 328, and a high-power remote unit (dHRU) 330. The DRU 322 is also configured to combine uplink communications signals 320U received from the LPR 324, the dRAU 326, the dMRU 328, and the dHRU 330 and provide the combined uplink communications signals to the digital BBU 318. The digital BBU 318 is also configured to interface with a third-party central unit 332 and/or an analog source 334 through a radio frequency (RF)/digital converter 336.

The DRU 322 may be coupled to the LPR 324, the dRAU 326, the dMRU 328, and the dHRU 330 via an optical fiber-based communications medium 338. In this regard, the DRU 322 can include a respective electrical-to-optical (E/O) converter 340 and a respective optical-to-electrical (O/E) converter 342. Likewise, each of the LPR 324, the dRAU 326, the dMRU 328, and the dHRU 330 can include a respective E/O converter 344 and a respective O/E converter 346.

The E/O converter 340 at the DRU 322 is configured to convert the downlink communications signals 320D into downlink optical communications signals 348D for distribution to the LPR 324, the dRAU 326, the dMRU 328, and the dHRU 330 via the optical fiber-based communications medium 338. The O/E converter 346 at each of the LPR 324, the dRAU 326, the dMRU 328, and the dHRU 330 is configured to convert the downlink optical communications signals 348D back to the downlink communications signals 320D. The E/O converter 344 at each of the LPR 324, the dRAU 326, the dMRU 328, and the dHRU 330 is configured to convert the uplink communications signals 320U into uplink optical communications signals 348U. The O/E converter 342 at the DRU 322 is configured to convert the uplink optical communications signals 348U back to the uplink communications signals 320U.

In context of the present disclosure, a radio access node refers generally to a wireless communication circuit including at least a processing circuit, a memory circuit, and an antenna circuit, and can be configured to process, transmit, and receive a wireless communications signal. In an embodiment, the radio node 304 can be configured according to embodiments of the present disclosure to help improve downlink decoding reliability in the WCS 300.

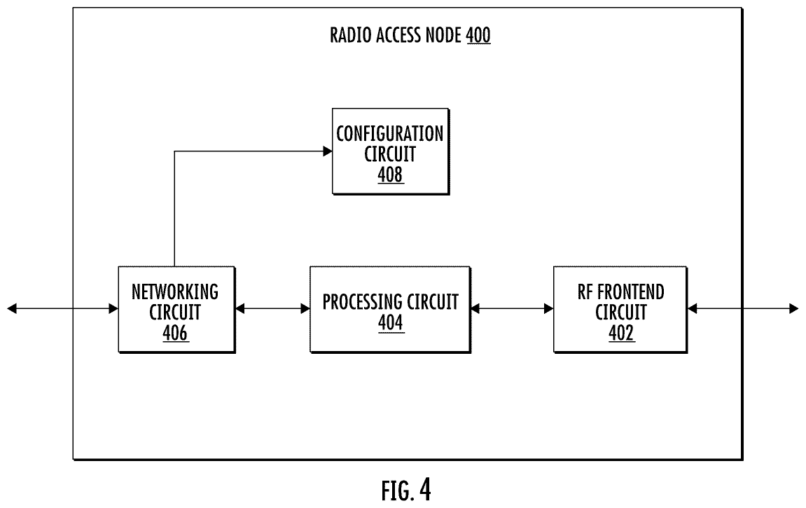

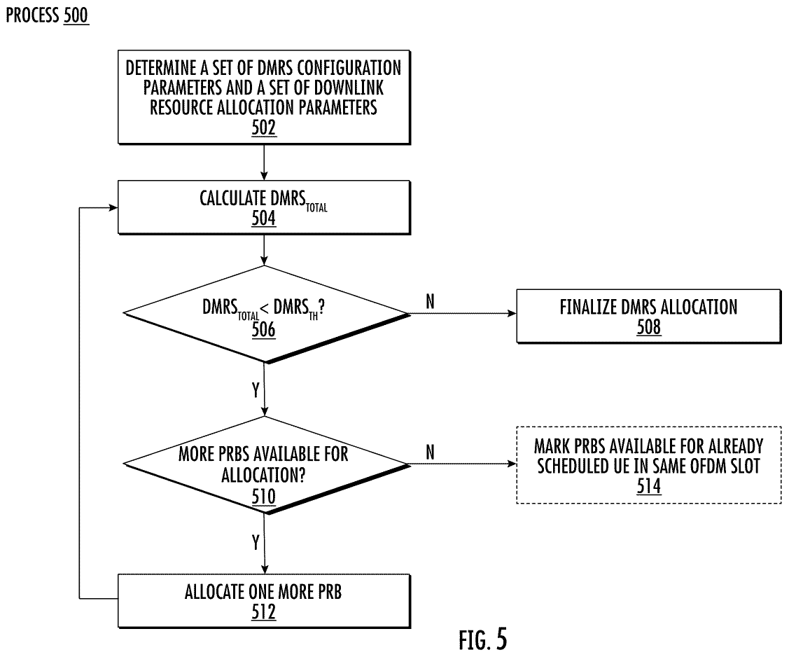

FIG. 4 is a schematic diagram of an exemplary radio access node 400, which can function as the radio node 304 in the WCS 300 of FIG. 3 to help improve downlink decoding reliability in the WCS 300. In an embodiment, the radio access node 400 includes a radio frequency (RF) frontend circuit 402, a processing circuit 404, a networking circuit 406, and a configuration circuit 408.

The RF frontend circuit 402, which can include a power amplifier(s), a low-noise amplifier(s), a power management integrated circuit(s), a transmit/receive filter circuit(s), and an antenna circuit(s), can be configured to communicate downlink and uplink signals. The processing circuit 404, which can be a field-programmable gate array (FPGA), an application-specific integrated circuit (ASIC), or a general-purpose processor, as an example, can be configured to allocate enough DMRS symbols in the PRB 200 to help improve downlink decoding reliability in the WCS 300. The networking circuit 406 can be configured to exchange control-plane messages X2-C and user-plane messages X2-U directly with other network control entities. The configuration circuit 408, which may be a memory circuit, as an example, is configured to store communication protocols of all open system interconnection (OSI) layers, including but not limited to LTE and 5G communication protocols. Herein, the configuration circuit 408 can also be preconfigured to store the DMRS configuration parameters (e.g., mapping type, configuration type, and total number of DMRS symbols per OFDM slot) and the downlink resource allocation parameters (e.g., BWPSize).

The radio access node 400 may be configured to improve downlink decoding reliability in the WCS 300 based on a process. In this regard, FIG. 5 is a flowchart of an exemplary process 500 whereby the radio access node 400 of FIG. 4 can help improve downlink decoding reliability in the WCS 300 according to embodiments of the present disclosure.

Herein, the radio access node 400 first determines a set of DMRS configuration parameters and a set of downlink resource allocation parameters (block 502). In an embodiment, the DMRS configuration parameters include the mapping type (A or B), the configuration type (1 or 2), and the total number of DMRS symbols that can be provided in the OFDM slot. The DMRS configuration parameters may be stored in the configuration circuit 408.

Next, the radio access node 400 calculates a total number of DMRS symbols (denoted as DMRS_{TOTAL}) that has been presently allocated to a selected UE based on the DMRS configuration parameters (block 504). The radio access node 400 then compares the total number of DMRS symbols DMRS_{TOTAL} against a predefined threshold DMRS_{TH} to determine whether the total number of DMRS symbols DMRS_{TOTAL} is lower than the predefined threshold DMRS_{TH} (block 506). In an embodiment, the predefined threshold DMRS_{TH} may be determined through simulation and/or field testing and stored in the configuration circuit 408.

If the total number of DMRS symbols DMRS_{TOTAL} is not lower than the predefined threshold DMRS_{TH}, the radio access node 400 can thus conclude that enough DMRS symbols have already been allocated to the UE. Accordingly, the radio access node 400 can finalize the DMRS allocation for the UE (block 508).

If the radio access node 400 determines that the total number of DMRS symbols DMRS_{TOTAL} is indeed lower than the predefined threshold DMRS_{TH}, the radio access node 400 will then check to see whether it is possible to allocate more PRBs to the UE (block 510). In an embodiment, the radio access node 400 may check the downlink resource allocation parameters, as stored in the configuration circuit 408, to determine whether it is possible to allocate more PRBs to the UE.

In case more PRBs can be allocated to the UE, the radio access node 400 will allocate one more PRB to the UE (block 512) and then return to block 504 to recalculate the total number of DMRS symbols DMRS_{TOTAL}. In this regard, the recalculated total number of DMRS symbols DMRS_{TOTAL} will include the DMRS symbols in the newly allocated PRB.

If the radio access node 400 determines that no more PRBs can be allocated to the UE, the radio access node 400 may mark PRBs available for an already scheduled UE in the same OFDM slot (block 514). In other words, it may be possible to reuse some of the DMRS symbols that have been allocated to other UEs in the OFDM slot.

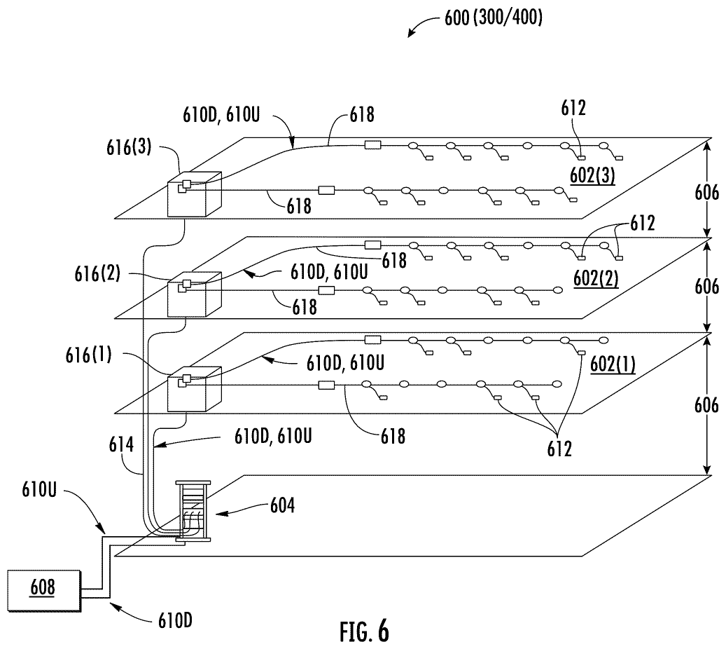

The WCS 300 of FIG. 3, which can include the radio access node 400 in FIG. 4, can be provided in an indoor environment as illustrated in FIG. 6. FIG. 6 is a partial schematic cut-away diagram of an exemplary building infrastructure 600 in a WCS, such as the WCS 300 of FIG. 3 that includes the radio access node 400 of FIG. 4 to help improve downlink decoding reliability in the WCS 300 according to embodiments of the present disclosure. The building infrastructure 600 in this embodiment includes a first (ground) floor 602(1), a second floor 602(2), and a third floor 602(3). The floors 602(1)-602(3) are serviced by a central unit 604 to provide antenna coverage areas 606 in the building infrastructure 600. The central unit 604 is communicatively coupled to a base station 608 to receive downlink communications signals 610D from the base station 608. The central unit 604 is communicatively coupled to a plurality of remote units 612 to distribute the downlink communications signals 610D to the remote units 612 and to receive uplink communications signals 610U from the remote units 612, as previously discussed above. The downlink communications signals 610D and the uplink communications signals 610U communicated between the central unit 604 and the remote units 612 are carried over a riser cable 614. The riser cable 614 may be routed through interconnect units (ICUs) 616(1)-616(3) dedicated to each of the floors 602(1)-602(3) that route the downlink communications signals 610D and the uplink communications signals 610U to the remote units 612 and also provide power to the remote units 612 via array cables 618.

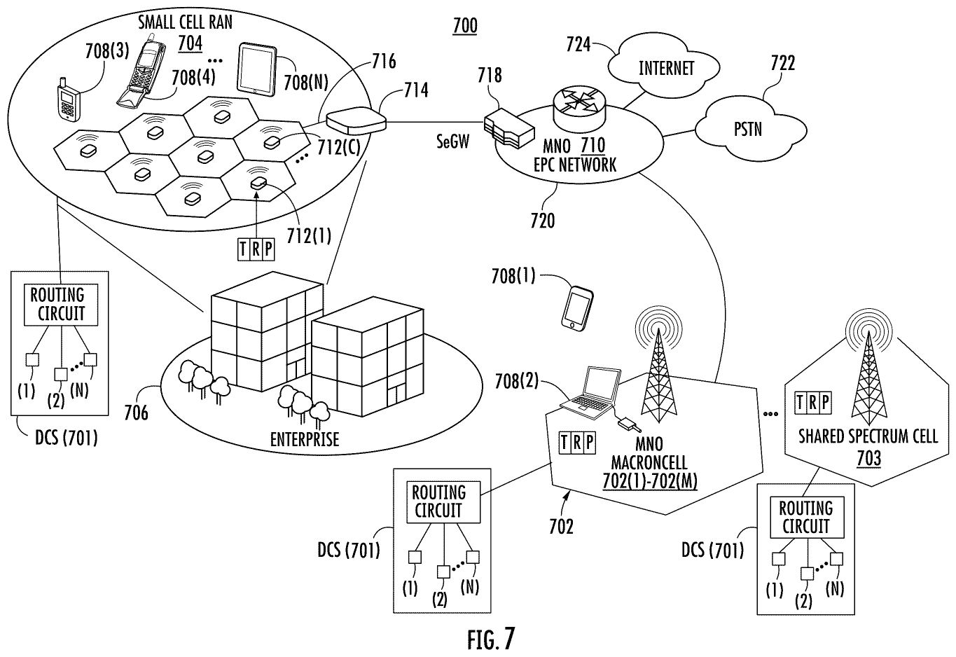

The WCS 300 of FIG. 3, which can include the radio access node 400 of FIG. 4, configured to improve downlink decoding reliability in the WCS 300, can also be interfaced with different types of radio nodes of service providers and/or supporting service providers, including macrocell systems, small cell systems, and remote radio heads (RRH) systems, as examples. For example, FIG. 7 is a schematic diagram of an exemplary mobile telecommunications environment 700 (also referred to as “environment 700”) that includes radio nodes and cells that may support shared spectrum, such as unlicensed spectrum, and can be interfaced to shared spectrum WCSs 701 supporting coordination of distribution of shared spectrum from multiple service providers to remote units to be distributed to subscriber devices. The shared spectrum WCSs 701 can include the WCS 300 of FIG. 3 that includes the radio access node 400 of FIG. 4, as an example.

The environment 700 includes exemplary macrocell RANs 702(1)-702(M) (“macrocells 702(1)-702(M)”) and an exemplary small cell RAN 704 located within an enterprise environment 706 and configured to service mobile communications between a user mobile communications device 708(1)-708(N) to a mobile network operator (MNO) 710. A serving RAN for the user mobile communications devices 708(1)-708(N) is a RAN or cell in the RAN in which the user mobile communications devices 708(1)-708(N) have an established communications session with the exchange of mobile communications signals for mobile communications. Thus, a serving RAN may also be referred to herein as a serving cell. For example, the user mobile communications devices 708(3)-708(N) in FIG. 7 are being serviced by the small cell RAN 704, whereas the user mobile communications devices 708(1) and 708(2) are being serviced by the macrocell 702. The macrocell 702 is an MNO macrocell in this example. However, a shared spectrum RAN 703 (also referred to as “shared spectrum cell 703”) includes a macrocell in this example and supports communications on frequencies that are not solely licensed to a particular MNO, such as CBRS for example, and thus may service user mobile communications devices 708(1)-708(N) independent of a particular MNO. For example, the shared spectrum cell 703 may be operated by a third party that is not an MNO and wherein the shared spectrum cell 703 supports CBRS. Also, as shown in FIG. 7, the MNO macrocell 702, the shared spectrum cell 703, and/or the small cell RAN 704 can interface with a shared spectrum WCS 701 supporting coordination of distribution of shared spectrum from multiple service providers to remote units to be distributed to subscriber devices. The MNO macrocell 702, the shared spectrum cell 703, and the small cell RAN 704 may be neighboring radio access systems to each other, meaning that some or all can be in proximity to each other such that a user mobile communications device 708(3)-708(N) may be able to be in communications range of two or more of the MNO macrocell 702, the shared spectrum cell 703, and the small cell RAN 704 depending on the location of the user mobile communications devices 708(3)-708(N).

In FIG. 7, the mobile telecommunications environment 700 in this example is arranged as an LTE system as described by the Third Generation Partnership Project (3GPP) as an evolution of the GSM/UMTS standards (Global System for Mobile communication/Universal Mobile Telecommunications System). It is emphasized, however, that the aspects described herein may also be applicable to other network types and protocols. The mobile telecommunications environment 700 includes the enterprise environment 706 in which the small cell RAN 704 is implemented. The small cell RAN 704 includes a plurality of small cell radio nodes 712(1)-712(C). Each small cell radio node 712(1)-712(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 7, the small cell RAN 704 includes one or more services nodes (represented as a single services node 714) that manage and control the small cell radio nodes 712(1)-712(C). In alternative implementations, the management and control functionality may be incorporated into a radio node, distributed among nodes, or implemented remotely (i.e., using infrastructure external to the small cell RAN 704). The small cell radio nodes 712(1)-712(C) are coupled to the services node 714 over a direct or local area network (LAN) connection 716 as an example, typically using secure IPsec tunnels. The small cell radio nodes 712(1)-712(C) can include multi-operator radio nodes. The services node 714 aggregates voice and data traffic from the small cell radio nodes 712(1)-712(C) and provides connectivity over an IPsec tunnel to a security gateway (SeGW) 718 in a network 720 (e.g., evolved packet core (EPC) network in a 4G network, or 5G Core in a 5G network) of the MNO 710. The network 720 is typically configured to communicate with a public switched telephone network (PSTN) 722 to carry circuit-switched traffic, as well as for communicating with an external packet-switched network such as the Internet 724.

The environment 700 also generally includes a node (e.g., eNodeB or gNodeB) base station, or “macrocell” 702. The radio coverage area of the macrocell 702 is typically much larger than that of a small cell where the extent of coverage often depends on the base station configuration and surrounding geography. Thus, a given user mobile communications device 708(3)-708(N) may achieve connectivity to the network 720 (e.g., EPC network in a 4G network, or 5G Core in a 5G network) through either a macrocell 702 or small cell radio node 712(1)-712(C) in the small cell RAN 704 in the environment 700.

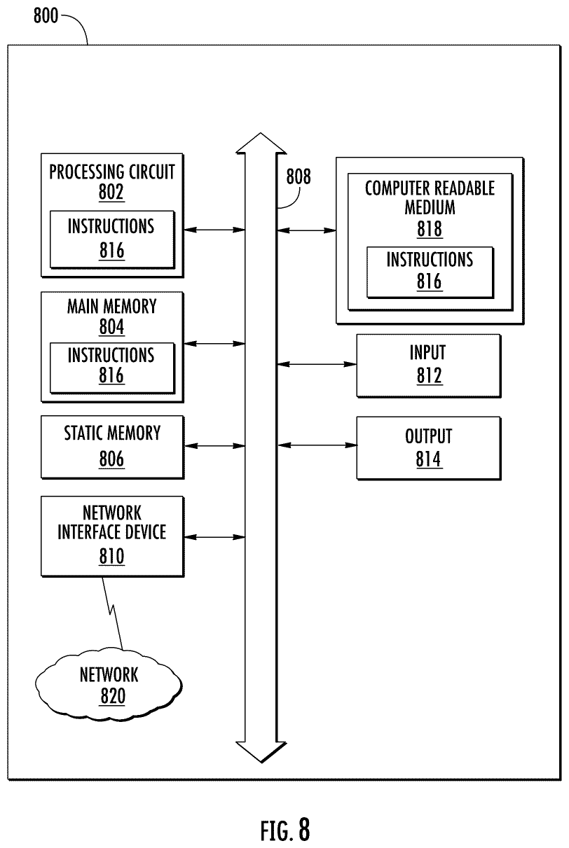

Any of the circuits in the WCS 300 of FIG. 3 and the radio access node 400 of FIG. 4, such as the processing circuit 404, can include a computer system 800, such as that shown in FIG. 8, to carry out their functions and operations. With reference to FIG. 8, the computer system 800 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 800 in this embodiment includes a processing circuit or processor 802, a main memory 804 (e.g., read-only memory (ROM), flash memory, dynamic random access memory (DRAM) such as synchronous DRAM (SDRAM), etc.), and a static memory 806 (e.g., flash memory, static random access memory (SRAM), etc.), which may communicate with each other via a data bus 808. Alternatively, the processing circuit 802 may be connected to the main memory 804 and/or static memory 806 directly or via some other connectivity means. The processing circuit 802 may be a controller, and the main memory 804 or static memory 806 may be any type of memory.

The processing circuit 802 represents one or more general-purpose processing circuits such as a microprocessor, central processing unit, or the like. More particularly, the processing circuit 802 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 802 is configured to execute processing logic in instructions 816 for performing the operations and steps discussed herein.

The computer system 800 may further include a network interface device 810. The computer system 800 also may or may not include an input 812 to receive input and selections to be communicated to the computer system 800 when executing instructions. The computer system 800 also may or may not include an output 814, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 800 may or may not include a data storage device that includes instructions 816 stored in a computer-readable medium 818. The instructions 816 may also reside, completely or at least partially, within the main memory 804 and/or within the processing circuit 802 during execution thereof by the computer system 800, the main memory 804 and the processing circuit 802 also constituting the computer-readable medium 818. The instructions 816 may further be transmitted or received over a network 820 via the network interface device 810.

While the computer-readable medium 818 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the processing circuit and that cause the processing circuit to perform any one or more of the methodologies of the embodiments disclosed herein. The term “computer-readable medium” shall accordingly be taken to include, but not be limited to, solid-state memories, optical and magnetic medium, and carrier wave signals.

Note that as an example, any “ports,” “combiners,” “splitters,” and other “circuits” mentioned in this description may be implemented using Field Programmable Logic Array(s) (FPGA(s)) and/or a digital signal processor(s) (DSP(s)), and therefore, may be embedded within the FPGA or be performed by computational processes.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A radio access node, configured to:
calculate a total number of demodulation reference signal (DMRS) symbols allocated to a selected user equipment (UE);
determine whether the total number of DMRS symbols allocated to the selected UE is lower than a predefined threshold; and
if the determined total number of allocated DMRS symbols is lower than the predefined threshold, allocate one or more additional physical resource blocks (PRBs) to the selected UE until the total number of DMRS symbols allocated to the selected UE is higher than or equal to the predefined threshold.

2. The radio access node of claim 1, further configured to calculate the total number of DMRS symbols allocated to the selected UE based on a set of DMRS configuration parameters and a set of downlink resource allocation parameters.

3. The radio access node of claim 2, wherein:
the set of DMRS configuration parameters comprises a mapping type, a configuration type, and a total number of DMRS symbols that can be configured in an orthogonal frequency division multiplexing (OFDM) slot; and
the set of downlink resource allocation parameters comprises a bandwidth part size.

4. The radio access node of claim 1, further configured to:
determine whether an additional PRB can be allocated to the selected UE when the total number of DMRS symbols allocated to the selected UE is lower than the predefined threshold;
allocate the additional PRB to the selected UE in response to determining that the additional PRB can be allocated to the selected UE; and
recalculate the total number of DMRS symbols after allocating the additional PRB allocated to the selected UE.

5. The radio access node of claim 4, further configured to reuse one or more DMRS symbols already allocated to another UE in a same OFDM slot in response to determining that the additional PRB cannot be allocated to the selected UE.

6. A method for improving downlink decoding reliability in a wireless communications system (WCS), comprising:
calculating a total number of demodulation reference signal (DMRS) symbols allocated to a selected user equipment (UE);
determining whether the total number of DMRS symbols allocated to the selected UE is lower than a predefined threshold; and
if the determined total number of allocated DMRS symbols is lower than the predefined threshold, allocating one or more additional physical resource blocks (PRBs) to the selected UE until the total number of DMRS symbols allocated to the selected UE is higher than or equal to the predefined threshold.

7. The method of claim 6, further comprising calculating the total number of DMRS symbols allocated to the selected UE based on a set of DMRS configuration parameters and a set of downlink resource allocation parameters.

8. The method of claim 7, wherein:
the set of DMRS configuration parameters comprises a mapping type, a configuration type, and a total number of DMRS symbols that can be configured in an orthogonal frequency division multiplexing (OFDM) slot; and
the set of downlink resource allocation parameters comprises a bandwidth part size.

9. The method of claim 6, wherein allocating the one or more additional PRBs to the selected UE comprises:
determining whether an additional PRB can be allocated to the selected UE when the total number of DMRS symbols allocated to the selected UE is lower than the predefined threshold;
allocating the additional PRB to the selected UE in response to determining that the additional PRB can be allocated to the selected UE; and
recalculating the total number of DMRS symbols after allocating the additional PRB allocated to the selected UE.

10. The method of claim 9, further comprising reusing one or more DMRS symbols already allocated to another UE in a same OFDM slot in response to determining that the additional PRB cannot be allocated to the selected UE.

11. A wireless communications system (WCS), comprising at least one radio access node configured to:
calculate a total number of demodulation reference signal (DMRS) symbols allocated to a selected user equipment (UE);
determine whether the total number of DMRS symbols allocated to the selected UE is lower than a predefined threshold; and
if the determined total number of allocated DMRS symbols is lower than the predefined threshold, allocate one or more additional physical resource blocks (PRBs) to the selected UE until the total number of DMRS symbols allocated to the selected UE is higher than or equal to the predefined threshold.

12. The WCS of claim 11, wherein the at least one radio access node is further configured to calculate the total number of DMRS symbols allocated to the selected UE based on a set of DMRS configuration parameters and a set of downlink resource allocation parameters.

13. The WCS of claim 12, wherein:
the set of DMRS configuration parameters comprises a mapping type, a configuration type, and a total number of DMRS symbols that can be configured in an orthogonal frequency division multiplexing (OFDM) slot; and
the set of downlink resource allocation parameters comprises a bandwidth part size.

14. The WCS of claim 11, wherein the at least one radio access node is further configured to:
determine whether an additional PRB can be allocated to the selected UE when the total number of DMRS symbols allocated to the selected UE is lower than the predefined threshold;
allocate the additional PRB to the selected UE in response to determining that the additional PRB can be allocated to the selected UE; and
recalculate the total number of DMRS symbols after allocating the additional PRB allocated to the selected UE.

15. The WCS of claim 14, further configured to reuse one or more DMRS symbols already allocated to another UE in a same OFDM slot in response to determining that the additional PRB cannot be allocated to the selected UE.

16. The WCS of claim 11, further comprising:
a distribution unit coupled to the at least one radio access node;
a digital routing unit coupled to the distribution unit; and
a plurality of remote units coupled to the digital routing unit via a plurality of optical fiber-based communications mediums.

17. The WCS of claim 16, wherein:
the digital routing unit comprises:
an electrical-to-optical (E/O) converter configured to convert a plurality of downlink communications signals into a plurality of downlink optical communications signals, respectively; and
an optical-to-electrical (O/E) converter configured to convert a plurality of uplink optical communications signals into a plurality of uplink communications signals, respectively; and
the plurality of remote units each comprises:
a respective O/E converter configured to convert a respective one of the plurality of downlink optical communications signals into a respective one of the plurality of downlink communications signals; and
a respective E/O converter configured to convert a respective one of the plurality of uplink communications signals into a respective one of the plurality of uplink optical communications signals.
